(19) United States
(12) Patent Application Publication
(10) Pub. No.: US 2008/0037459 A1
(43) Pub. Date: Feb. 14, 2008

(54) ENABLING DYNAMIC REGISTRATION OF MOBILE STATIONS AT AN ACCESS NETWORK IN A HIGH DATA RATE WIRELESS NETWORK

(76) Inventors: MINGSHEN GAO, Batavia, IL (US); Yifei Yuan, Kearny, NJ (US)

Correspondence Address: WILLIAMS, MORGAN & AMERSON, 10333 RICHMOND, SUITE 1100, HOUSTON, TX, 77042, US

(21) Appl. No.: 11/464,382

(22) Filed: Aug. 14, 2006

(51) Int. Cl. H04Q 7/00

(52) U.S. Cl. 370/328

(57) ABSTRACT

A method and an apparatus are provided for obtaining dynamic registration by at least one mobile station to an access network in a high data rate wireless network. The method may include reporting location information of the at least one mobile station to the access network based on strength of pilots associated with a first set of candidate cell sectors from which the mobile station anticipates switching to a second set of target cell sectors. The method may further include registering for a dynamic broadcast-multicast service in the high data rate wireless network based on the location information of the at least one mobile station. In another embodiment of the present invention, a method and an apparatus are provided for providing dynamic registration to one or more participating mobile stations at an access network in a high data rate wireless network. The method includes receiving location information based on strength of pilots associated with a first set of candidate cell sectors from each of the one or more participating mobile stations for determining whether to switch to a second set of target cell sectors in response to a handoff. The method may further include registering users of a dynamic broadcast-multicast service content in the high data rate wireless network by using the greatest-common set of cell sectors from the target cell sectors requested by the one or more participating mobile stations.

### BACKGROUND OF THE INVENTION

1. Field of the Invention

This invention relates generally to communication systems, and, more particularly, to wireless communication systems.

2. Description of the Related Art

A wireless communication system provides wireless connectivity to mobile stations (MSs) such as the cellular telephones, personal data assistants, smart phones, pagers, text messaging devices, Global Positioning System devices, wireless network interface cards, desktop or laptop computers, and the like. To provide wireless connectivity to mobile stations, many wireless communication systems include one or more access networks (ANs), which may also be referred to as node-Bs, base stations, and base station routers. For example, access networks in the wireless communication system may provide wireless connectivity to mobile stations located in geographical areas, or cells, associated with the access networks. By accessing an access network, a mobile station may establish a connection with other mobile stations on the reverse link and the forward link.

The coverage area of a wireless communication system is typically divided into a number of cells, which may be grouped into one or more networks. Mobile stations located in each cell may access the wireless communications system by establishing a wireless communication link, often referred to as an air interface, with a base station associated with the cell. As a mobile station moves between cells in the wireless communication system, the mobile station may periodically provide route update messages or location update messages that inform the wireless communication system of the mobile station's current location. Due to the mobility of the mobile station, the location of the cell where the most recent route update message was received is used to estimate the current location of the mobile station.

In many wireless communication systems, a base station may broadcast multi-media traffic of video, data, multimedia, and/or voice to a number of users demanding that service within the coverage area of the base station. For example, multimedia traffic for a service may include a video stream associated with an event such as a sports event or a news event.

Several mobile network operators and/or service providers provide a host of mobile services to users of mobile terminals. A multi-media service may stream content to mobile terminals over point-to-point connections. For example, in a voice, a download, or a streaming session, a client-server connection may be used for messaging, on-demand, streaming and download services based on point-to-point communication. To several mobile terminals, however, a multi-media service may be either broadcast or multicast. The broadcast and multicast may be based on a point-to-multipoint communication in which data packets may be simultaneously transmitted from a single source to multiple destinations.

While the term broadcast commonly refers to delivering service content to all the participating or active users in the coverage area, the term multicast refers to delivering the service content to users of a particular group. Examples of broadcast services include radio and television services broadcasted over an air interface (e.g., terrestrial, satellite) and over cable networks. One exemplary group of users of multicast services may subscribe to common content such as sports, news, entertainment and the like. A multicast-enabled network distributes service content over selected links that serve receivers belonging to the users of that multicast group. By selectively delivering services to user groups, multicasting may deliver radio services over the Internet.

For example, a broadcast-multicast service (BCMCS) may be incorporated into a cdma2000 standard based wireless telecommunications networks. By using the broadcast-multicast service, a base station may simultaneously transmit an information stream with the same to multiple mobile stations. To send the common (same) information to multiple users, this service may efficiently use air interface and network resources. Examples of the common (same) information that may be transmitted to multiple users include data (e.g. text), multimedia (e.g., voice) and streaming media. In particular, the broadcast-multicast service (BCMCS) is an important feature in EVolution of the cdma2000 EV-DO. The broadcast-multicast service enables operators to provide a variety of high data rate applications more efficiently than by using traditional unicast or point-to-point mode of communications. In the broadcast-multicast service, mobile terminals may not maintain continuous a Reverse Link connection to the access network, thus saving quite a significant amount of reverse link radio resource. Accordingly, the broadcast-multicast service may be used for a group call using Voice over IP (VoIP). Such a call could be established, for example, using popular “walkie-talkie” techniques where speech from the user controlling communication “floor” is distributed to the predefined or ad-hoc talk group members by a special server.

While the transmission over the broadcast-multicast service may be an efficient way to serve a group collectively, broadcast-multicast service lacks the acknowledgement/non-acknowledgement (ACK/NACK) signaling which is available in unicast mode through the reverse link. The ACK/NACK signaling can early terminate Hybrid Automatic Repeat-reQuest (ARQ) retransmission if decoding is successful before the target number of transmissions and, thus, improving transmission efficiency in fading channels. Although Media Access Control (MAC) layer Reed-Solomon (R-S) codes can be used to improve the link performance of broadcast-multicast service, the excessive delay associated with R-S codes does not fit the latency-sensitive applications such as VoIP.

Physical layer soft combining is an effective way to improve the cell coverage when signals from multiple sectors are added in a constructive manner. To avoid collisions, sectors participating in soft combining need to coordinate their broadcast-multicast service resource allocation and transmit the same content in the same forward link slots. Apparently the cell coverage improvement in soft combining case comes at the cost of fewer unique contents that can be broadcast/multicast over a number of neighboring sectors. Therefore, rather than blindly broadcasting over a wide region with many sectors, which is the normal procedure in static broadcasting cases, it is desired that the access network would pick only those sectors that can make significant soft combining contributions and deliver the content to recipients only though the necessary sectors.

However, for a broadcast-multicast service a sector starts broadcasting or joins the already established broadcasting (i.e., to participate soft combining) only when a mobile station sends a request for its broadcast-multicast service content. This request is sent when the mobile station cannot find the content ID from Broadcast overhead Message (BoM) sent from the new sector in the case when the mobile station is switching sectors. This mechanism causes service interruption and, even worse, the quality of the reception could have suffered significantly even before it reaches the switching point. Alternatively, to compensate for this situation, lowering of data rate may be effected as the broadcast-multicast service data rate is based on the mobile stations at the edge of the cell.

One potential service gap and an indication of degradation for quality of the reception associated with the mechanism set forth above is illustrated in FIG. 1 where a conventional wireless communication system 100 based on a three-sector arrangement 105 for cells is shown in which each sector 105(1) is shaped as a hexagon. A group of three neighboring sectors 105(1-3) form a corresponding clover-leaf shaped cell 120 with a base station 125 at the center. When a mobile station 130 is located at a position A, the three sectors (S1, S2 and S3) may participate in soft combining while the mobile station 130 listens to Broadcast overhead Message (BoM) from S2 which is the closest. As the mobile station 130 crosses the dashed line and moves toward a position B, ideally an access network 135 may not release the radio resource in the sectors S1 and S3 for broadcasting to this mobile station 130. The access network 135 may not remove the sectors S1 and S3 from the soft combining set either, at the same time, to allocate the radio resource in the sectors S4 and S5 for broadcasting. That is, it may not add the sectors S4 and S5 to the soft combining set so that the soft combining gain can be achieved fully without any handoff disruptions.

However, the access network 135 may not provide such a smooth handoff because the mobile station 130 does not provide information about its locations before reaching the position B. The mobile station 130 to report locates the broadcast content ID from BoM sent from the sector S2 which still happens to be the closest until now. After passing the position B, the mobile station 130 begins to listen to BoM from S5 which becomes the closest. Since the sector S5 did not anticipate the mobile station's 130 coming, its BoM does not contain the broadcast content ID for the mobile station 130. Therefore, the mobile station 130 is forced to re-register by performing broadcast-multicast service registration to the access network 135 from the sector S5. Upon becoming aware of the whereabouts of the mobile station 130, the access network 135 adds the sector S5 to the soft combining set. However, the soft combining gain is still impacted by the sector S4 since it is not yet being counted so it continues to cause interference until it is included. Thus, the signal reception between the position A and the position B (a relatively longer considering the rather infrequent BoM) is significantly poorer, not only due to the insufficient number of soft combining legs, but also because of the increasing interference coming from the sectors S4 and S5 which might otherwise serve as the desired signals.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one embodiment of the present invention, a method of obtaining dynamic registration by at least one mobile station to an access network in a high data rate wireless network is provided. The method includes reporting location information of the at least one mobile station to the access network based on strength of pilots associated with a first set of candidate cell sectors from which the mobile station anticipates switching to a second set of target cell sectors. The method may further include registering for a dynamic broadcast-multicast service in the high data rate wireless network based on the location information of the at least one mobile station.

In another embodiment of the present invention, a method is provided for providing dynamic registration to one or more participating mobile stations at an access network in a high data rate wireless network. The method includes receiving location information based on strength of pilots associated with a first set of candidate cell sectors from each of the one or more participating mobile stations for determining whether to switch to a second set of target cell sectors in response to a handoff. The method may further include registering users of a dynamic broadcast-multicast service content in the high data rate wireless network by using the greatest-common set of cell sectors from the target cell sectors requested by the one or more participating mobile stations.

### BRIEF DESCRIPTION OF THE DRAWINGS

The invention may be understood by reference to the following description taken in conjunction with the accompanying drawings, in which like reference numerals identify like elements, and in which:

FIG. 1 shows a conventional wireless communication system based on a three-sector arrangement for cells;

FIG. 2 conceptually illustrates a first exemplary embodiment of a wireless communication system based on a three-sector arrangement for cells that enables dynamic registration of mobile stations at an access network in a high data rate wireless network, in accordance with the present invention;

FIG. 3 conceptually illustrates one exemplary embodiment of a method of mobile location reporting for broadcast-multicast service (BCMCS) and an access network management for the greatest common set (GCS) of soft combine sectors for broadcasting, in accordance with the present invention;

FIG. 4 conceptually illustrates one exemplary embodiment of a method of obtaining dynamic registration by at least one mobile station to an access network in a high data rate wireless network, in accordance with the present invention;

FIG. 5 conceptually illustrates one exemplary embodiment of a method for providing dynamic registration to one or more participating mobile stations at an access network in a high data rate wireless network, in accordance with the present invention; and

FIG. 6 conceptually illustrates one embodiment of a chart that compares BCMCS supportable rates at 95% cell coverage and 1% frame error rate, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Generally, a method and an apparatus are provided for obtaining dynamic registration by at least one mobile station to an access network in a high data rate wireless network. The method may include reporting location information of the at least one mobile station to the access network based on strength of pilots associated with a first set of candidate cell sectors from which the mobile station anticipates switching to a second set of target cell sectors. The method may further include registering for a dynamic broadcast-multicast service in the high data rate wireless network based on the location information of the at least one mobile station. In another embodiment of the present invention, a method and an apparatus are provided for providing dynamic registration to one or more participating mobile stations at an access network in a high data rate wireless network. The method includes receiving location information based on strength of pilots associated with a first set of candidate cell sectors from each of the one or more participating mobile stations for determining whether to switch to a second set of target cell sectors in response to a handoff. The method may further include registering users of a dynamic broadcast-multicast service content in the high data rate wireless network by using the greatest-common set of cell sectors from the target cell sectors requested by the one or more participating mobile stations.

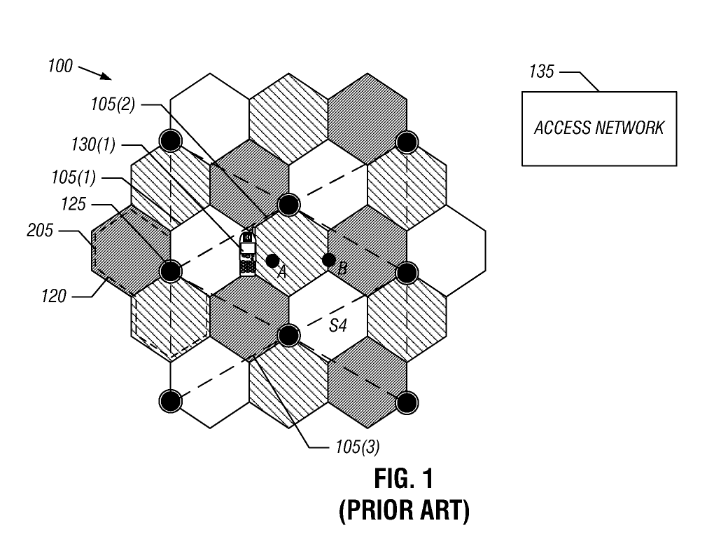

Referring to FIG. 1, a first exemplary embodiment of a wireless communication system 200 is illustrated based on an arrangement of three hexagon shaped cell sectors 205 that enables dynamic registration of one or more mobile stations 130(1-n) at the access network 135 associated with a high data rate wireless network 210 in accordance with the present invention. As used herein, the term “dynamic registration,” according to one embodiment, indicates registering by the mobile station 130(1) for a unidirectional point-to-multipoint service, such as a broadcast-multicast service (BCMCS) 215 when switching between one or more cell sectors 205. That is, for dynamic registration the mobile station 130(1) sends a request for content associated with the BCMCS 215, in response to being unable to find a conventional content identification (ID) from a Broadcast overhead Message (BoM) sent from a new cell sector.

Consistent with one embodiment of the present invention, the broadcast-multicast service (BCMCS) 215 may transfer video, audio clips, and real-time streaming using the Third Generation Partnership Project (3GPP) standard. By using broadcasting and/or multicasting for transmission, the broadcast-multicast service 215 may transmit data from a single source to a group of users in a specific service coverage area to provide mass communications. For example, in the wireless communication system 200, the broadcast-multicast service 215 may transfer data for multiple mobile stations 130(1-n) simultaneously using an Internet Protocol (IP) based datacast protocol over the high data rate wireless network 210. A service provider 220 coupled to the high data rate wireless network 210 may communicate with the access network 135 to provide the broadcast-multicast service 215 to the multiple mobile stations 130(1-n).

To transmit the data from a single source, such as the base station 125 to multiple mobile stations 130(1-n) in an associated service coverage area, the broadcast-multicast service (BCMCS) 215 may include at least one of two modes of service coverage, namely a broadcast service mode and/or a multicast service mode. In the broadcast service mode, data may be pushed to the multiple mobile stations 130(1-n) in an associated broadcast service area, while in the multicast service mode a unidirectional point-to-multipoint service may transmit data from a single source to a multicast group in an associated multicast service area. Thus, only those users that have subscribed to a specific multicast service by joining the multicast group associated with the multicast service may receive content for broadcast-multicast service (BCMCS) content. However, content for the broadcast-multicast service (BCMCS) 215 may be received without a specific interaction after subscription to a desired broadcast-multicast service from the users of the multiple mobile stations 130(1-n).

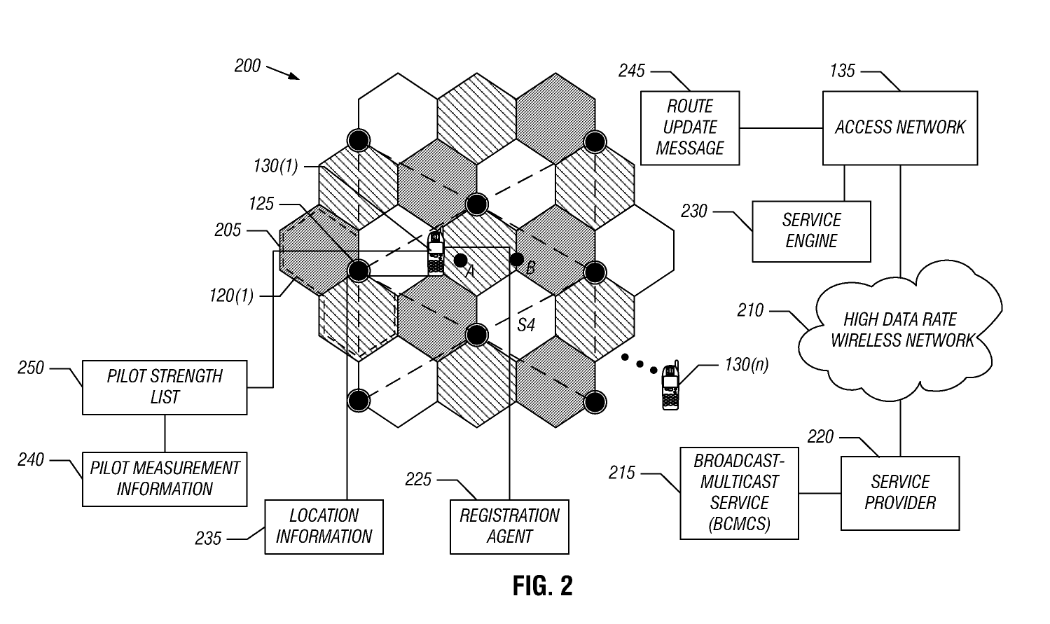

In one illustrative embodiment of the instant invention, the wireless communication system 200 is configured to provide wireless connectivity to a plurality of geographic areas or the clover-leaf shaped cells 205. The high data rate wireless network 210 may provide wireless connectivity according to one or more standards or protocols such as the Global System for Mobile communications (GSM), Universal Mobile Telecommunications System (UMTS), Code Division Multiple Access (CDMA, CDMA 2000), and the like for cellular network. However, the particular standards, protocols, or combinations thereof are matters of design choice and not material to the present invention. Persons of ordinary skill in the art having benefit of the present disclosure should also appreciate that base stations, base station routers, and the like may be used to provide a wireless connectivity to the cell sectors 205, although in the interest of clarity these devices are not shown in FIG. 2.

The access network 135 is deployed within the wireless communication system 200, which may provide wireless connectivity to at least one mobile station 130(1) of the multiple mobile stations 130(1-n). Persons of ordinary skill in the art should also appreciate that the mobile station 130(1) may also be referred to using terms such as “mobile unit,” “access terminal,” “user equipment,” “subscriber station,” “subscriber terminal,” and the like. Examples of the mobile stations 130(1-n) include, but are not limited to, cellular telephones, personal data assistants, smart phones, pagers, text messaging devices, global positioning devices, network interface cards, notebook computers, and desktop computers. Techniques for configuring and/or operating the mobile station 130(1) are known in the art and in the interest of clarity only those aspects of configuring and/or operating the mobile station 130(1) that are relevant to the present invention will be discussed further herein.

Although a single access network 135 is shown in FIG. 2, persons of ordinary skill in the art having benefit of the present disclosure should appreciate that any number of access networks may be deployed in the wireless communication system 200. In alternative embodiments, a wireless communication system may include other devices (such as radio network controllers) for connecting the cell sectors 205 to the wireless communication system 100. Techniques for configuring and/or operating the access networks 135 are known in the art and in the interest of clarity only those aspects of configuring and/or operating the access network 135 that are relevant to the present invention will be discussed further herein.

The mobile station 130(1) may comprise a registration agent 225 to obtain dynamic registration to the access network 135 in the high data rate wireless network 210. The registration agent 225 may register the mobile station 130(1) by exchanging information using registration messages between the mobile station 130(1) and the access network 135, For example, the registration agent 225 may communicate a foreign agent and/or a home agent to create or modify a mobility binding for the dynamic registration by associating the mobile station 130(1) with the broadcast-multicast service (BCMCS) 215 for a desired service session. The mobile station 130(1) may uniquely identify itself to the access network 135 based on a Network Access Identifier (NAI). Alternatively, the mobile station 130(1) may use a registration request message, such as in a Mobile IP registration request to register with the access network 135. The access network 135 may comprise a service engine 230 for returning a reply message to the mobile station 130(1) in response to the registration request message therefrom.

In operation, the registration agent 225 may report location information 235 of at least one mobile station, e.g., the mobile station 130(1) to the access network 135. To this end, the registration agent 225 may monitor strength of pilots from a first set of candidate cell sectors 205 to which the mobile station 130(1) anticipates switching to a second set of target cell sectors 205, in response to an indication of handoff from the base station 125. In particular, the registration agent 225 may measure pilot strength information 240 of one or more neighboring pilots of the pilots from the first set of candidate cell sectors 205.

The registration agent 225 may report the location information 235 based on the strength of pilots associated with the first set of candidate cell sectors to the service engine 230 at the access network 135. Accordingly, the mobile station 130(1) may register for a dynamic broadcast-multicast service, such as the BCMCS 215 in the high data rate wireless network 210 based on the location information 235 thereof. The service engine 230 may enable the access network 135 to soft combine a set of one or more cell sectors from the first set of candidate cell sectors 205 for the mobile station 130(1) in a physical layer. In other words, when the mobile station 130(1) transitions in the handoff, the service engine 230 may enable the access network 135 to support the dynamic broadcast-multicast service with the second set of target cell sectors 205 based on the location information 235 of that mobile station 130(1).

Consistent with one exemplary embodiment of the present invention, to report the location information 235 of the mobile station 130(1), the registration agent 225 may send a route update message 245 to the access network 135. That is, the route update message 245 may be sent in response to adding a new pilot to the first set of candidate cell sectors 205, while listening to a dynamic broadcast of content associated with the BCMCS 215 to determine whether the dynamic registration of the dynamic broadcast-multicast service is desired. As used herein, the term “route update message” will be understood to refer to any message that includes the location information 235 that may be used to determine a location of the mobile station 130(1).

However, in some embodiments of the present invention, the mobile station 130(1) may determine whether to provide the route update message 245 based on travel patterns thereof. For example, the mobile station 130(1) might refrain from providing the route update message 245 as long as it remains within one of the cells 120 in a travel pattern associated with a route. However, the mobile station 130(1) may conventionally provide the route update message 245 whenever it moves outside a predetermined radius from the center of a primary cell. In other words, as long as the mobile station 130(1) remains in one of the cell sectors 205 in the travel pattern associated with the route, the mobile station 130(1) may not provide any route update messages. If the mobile station 130(1) enters a cell 120 that is not in the travel pattern associated with the route, the mobile station 130(1) may then provide the route update message 245 to the access network 135.

According to one embodiment of the present invention, to periodically send a pilot strength list 250 to the access network 135, the registration agent 225 may sort the pilots associated with the first set of candidate cell sectors 205 based on the strength of pilots at the mobile station 130(1). In this way, the registration agent 225 may determine the location information 235 of the mobile station 130(1) based on the pilot measurement information 240 and the pilot strength list 250.

The service engine 230 may cause the access network 135 to select one or more cell sectors from the first set of candidate cell sectors 205 for the mobile station 130(1) to provide a desired service coverage area across one or more cells 120 of the access network 135 associated with the high data rate wireless network 210. For the purposes of broadcasting and/or multicasting the broadcast-multicast service (BCMCS) 215 based on the location information 235 of the mobile station 130(1), the service engine 230 may enable the access network 135 to form a soft combining set of the one or more cell sectors. To form the soft combining set, the service engine 230 may enable the access network 135 to use the greatest-common set (GCS) of cell sectors from a set of cell sectors which includes the first set of cell sectors 205 and other cell sectors that other participating mobile stations, such as the mobile station 130(n) request.

In the wireless communication system 200, according to one embodiment, the broadcast-multicast service (BCMCS) 215 may carry media traffic, such as video, data, multimedia, or other types of traffic and/or voice traffic. The base station 125 may broadcast and/or multicast the broadcast-multicast service 215 to a multicast group of users demanding the service within the service coverage area of the base station 125 or all the users in the service coverage area. That is, the base station 125 may transmit the broadcast-multicast service 215 to the users that demand the service through dedicated channels instead of broadcasting the service to all users in the service coverage area. Examples of the broadcast-multicast service 215 include a video stream of an event such as a sports event, a news event, or an entertainment event or episodes.

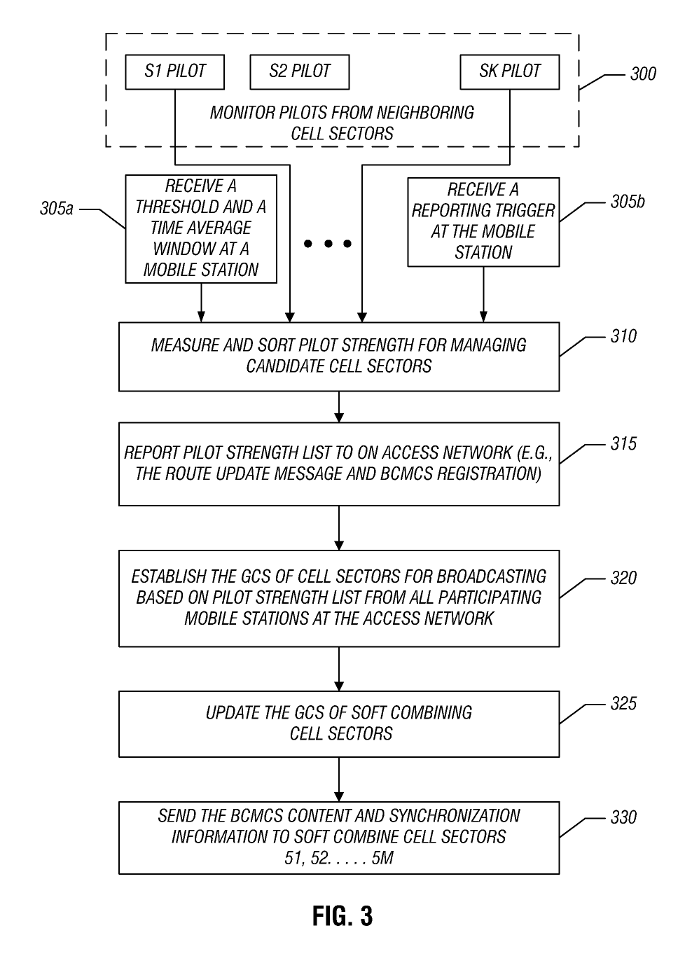

FIG. 3 conceptually illustrates one exemplary embodiment of a method of mobile location reporting for the broadcast-multicast service (BCMCS) 215 and the access network 135 management for the greatest-common set (GCS) of soft combine cell sectors to broadcast broadcast-multicast service 215 content, in accordance with the present invention. In particular, the mobile stations 130(1-n) may report their location related information to the access network 135. Based on location related information from all the participating mobile stations, the access network 135 may form a soft combining set of cell sectors by using the greatest-common set of cell sectors from sectors request by all the mobile stations 130(1-n) to effectively cover all the users of the BCMCS 215 content. With such a use of the greatest-common set (GCS) of cell sectors, the wireless communication system 200 may obtain a high-rate dynamic broadcast of the BCMCS 215 content.

Unlike unicast, in which the access network 135 may manage an active set for a single mobile station in unicasting, the greatest-common set of cell sectors may be used for a group of mobile stations for dynamic broadcasting instead of unicasting. However, either use of the active-set or forming of the greatest-common set of cell sectors may ensure that a given strongest pilot-set, of the cell sectors 205 that the mobile stations 130 may “listen” to, for the mobile stations 130(1-n) are covered. In this way, the greatest-common set of cell sectors may indicate an active set for the dynamic broadcasting.

At block 300, the mobile station 130(1) may monitor the pilots from nearby or neighboring cell sectors. For example, pilots form the cell sectors SIPilot to SkPilot may be monitored. However, such a monitored cell sector set is larger than a desired soft combining sector set. At block 305a, the mobile station 130(1) may receive a threshold and a time average window and a reporting trigger, as illustrated at block 305b. By using the threshold and the time average window, the mobile station 130(1) may filter out false pilots, for example, due to the noisy channels, fast fading, and the like.

At block 310, the mobile station 130(1) may continuously measure the neighboring pilots and update and/or manage its candidate set cell sectors regardless of from which cell sector the mobile station 130(1) listens to the Broadcast overhead Message (BoM). The mobile station 130(1) may sort the pilots based on their strengths for reporting to the access network 135 from time to time. In fact, the pilot measurement information 240 may be carried through the route update message 245, as defined consistent with a desired standard. A pilot set management based on a conventional function of managing pilots of a candidate set of cell sectors may be deployed in one exemplary embodiment.

At block 315, the pilot strength list 250 may be sent with a BCMCS registration message for the BCMCS service 215 handling in the access network 135 (i.e., the mobile station 130(1) may send a route update with a BCMCS-registration request together). A reporting frequency may be set so that the location information 235 is updated in such a manner that reduces a reporting overhead. Alternatively, as the mobile station 130(1) in a connected state listens to a unicast for the access network 135 to manage an active set for that mobile station, the mobile station 130(1) may send the route update message 245 when it adds new pilot to the first set of candidate cell sectors while the mobile station 130(1) listens to a dynamic broadcast for the dynamic BCMCS registration.

Once the access network 135 receives the pilot strength list 250 from each mobile station 130, it may add, delete and/or maintain the greatest-common set (GCS) of soft combining cell sectors, as indicated in block 320. The access network 135 may receive a list of pilot strength measurements from each of the one or more participating mobile stations for updating the greatest common set of soft combining cell sectors. Then, at block 330, the access network 135 may deliver the BCMCS service 215 content only to the updated GCS of soft combining cell sectors for broadcasting, for example S1, S2, to SM, as shown at block 325, to effectively use radio resources for broadcasting in the high data rate wireless network 210 without undesired degradation and service interruption. For example, by using a given minimum number of radio resources, delivery of the dynamic broadcast-multicast service content might be limited to only to the updated greatest common set of soft combining cell sectors.

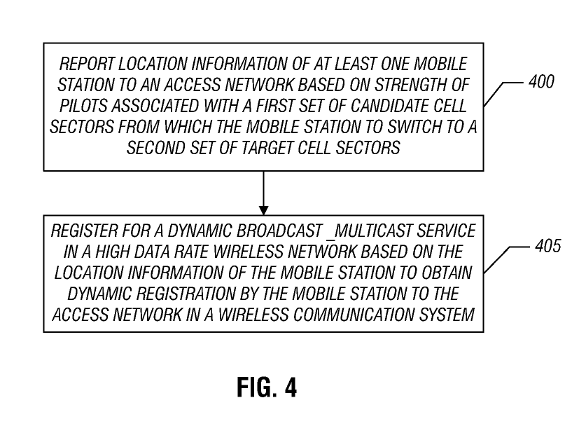

FIG. 4 conceptually illustrates one exemplary embodiment of a method of obtaining dynamic registration by the mobile station 130(1) to the access network 135 in the high data rate wireless network 210, in accordance with the present invention. At block 400, the mobile station 130(1) may report the location information 235 to the access network 135 based on strength of pilots associated with the first set of candidate cell sectors from which the mobile station 130(1) anticipates switching to the second set of target cell sectors. For obtaining dynamic registration to the access network 135, at block 405, the mobile station 130(1) may register for the dynamic broadcast-multicast service 215 in the high data rate wireless network 210 based on the location information 235 of the mobile station 130(1).

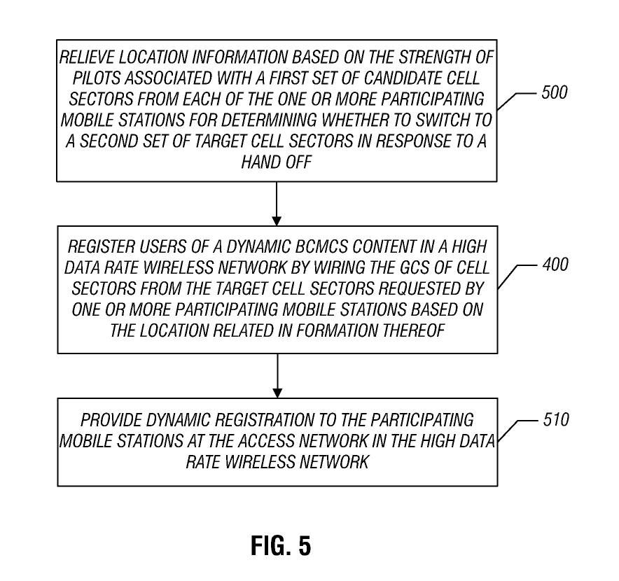

FIG. 5 conceptually illustrates one exemplary embodiment of a method for providing dynamic registration to one or more participating mobile stations 130 at the access network 135 in the high data rate wireless network 210, in accordance with the present invention. At block 500, the access network 135 may receive the location information 235 based on strength of pilots associated with the first set of candidate cell sectors from each of the one or more participating mobile stations 130 for determining whether to switch to the second set of target cell sectors in response to a handoff. In response to the route update message 245 from the mobile station 130(1) of the one or more participating mobile stations, the access network 135 may perform the handoff for the mobile station 130(1) to the second set of target cell sectors.

At block 505, the access network 135 may register users of the dynamic broadcast-multicast service (BCMCS) 215 content in the high data rate wireless network 210 by using the greatest-common set (GCS) of cell sectors from the target cell sectors requested by the one or more participating mobile stations 130 based on the location information 235 from the one or more participating mobile stations 130. The access network 135 may form the greatest-common set of cell sectors to manage an active set and by using the active set and the greatest-common set of cell sectors may provide a service coverage area across one or more cells to a set of pilots with a given strongest strength for the one or more participating mobile stations 130. The access network 135 may form the set of pilots with the given strongest strength for the one or more participating mobile stations 130 from the first set of candidate cell sectors of each of these participating mobile stations.

For determining the set of pilots with the given strongest strength, the access network 135 may cause the participating mobile stations 130 to listen to pilot signals of the first set of candidate cell sectors. The access network 135 may release one or more soft combining legs that are no longer useful, from a soft combining set of cell sectors based on the set of pilots with the given strongest strength. Accordingly, the access network 135 may provide dynamic registration to the one or more participating mobile stations 130 at the access network 135 in the high data rate wireless network 210.

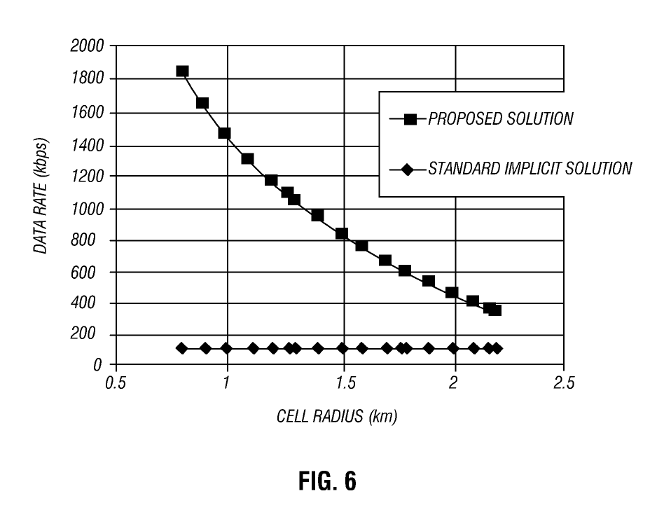

FIG. 6 conceptually illustrates one embodiment of a chart that compares BCMCS supportable rates at 95% cell coverage and 1% frame error rate, in accordance with the present invention. The Table 1 provides a set of exemplary parameters used be for a performance analysis of the BCMCS 215 in accordance with one embodiment of the present invention.

TABLE 1
Parameters for BCMCS performance analysis

| Parameters | Value | Comments |
|---|---|---|
| Base station transmit | 20 Watts | |
| power | | |
| Base station antenna | 70 deg (−3 dB) | |
| pattern | | |
| Base station antenna | 15 dB | 17 dB BS |
| gain including cable | | antenna gain; |
| loss | | 2 dB cable loss |
| Path loss model | 28.6 + 35log10(d) | Modified Hata |
| | dB, d in meters | urban model @1.9 GHz |
| | | (COST231) |
| Log-normal shadowing | Std = 8.9 dB | |
| Base station shadowing | 0.5 | |
| correlation | | |
| Mobile antenna gain | −1 dB | |
| Mobile noise figure | 10 dB | |
| Dual antenna mobile | Yes | Spatially independent |
| Thermal noise density | −174 dBm/Hz | |
| Carrier frequency | 1.9 GHz | |
| Other losses (e.g. | 10 dB | |
| building penetration) | | |
| Channel delay profile | single path | Jakes' model |

Based on a set of 3GPP2 simulation parameters listed in Table 1, the chart in FIG. 6 illustrates a calculated BCMCS supportable data rate vs. cell radius. In this analysis, the cell or service coverage considered is 95% and the frame error rate is less than 1%. As can be seen from the compared results in FIG. 6, the data rate of the wireless communication system 200 is relatively much higher than an implicit conventional procedure compliant with one of current industry standards. This is especially significant for small cell radius the difference is over a magnitude (the interference from nearby cell sectors remains regardless of how big or small the cell radius).

Embodiments of the techniques described above may have a number of advantages over conventional practice. Since the mobile stations 130(1-n) may provide the corresponding location information to the access network 135 not only when a mobile station re-registers to the access network 135, such a frequent location update provides a sufficient number of soft combining cell sectors and reduces interference. This significantly increases the coverage and data rate of the BCMCS 215. In one embodiment, the mobile station 130(1) may actively report to the access network 135 its location information 235 via the pilot measurement information 240. By using the route update message 245 for this reporting, the access network 135 may release the no longer useful soft combining legs and handoff the mobile station 130(1) to the second set of target cell sectors seamlessly.

In one embodiment, by using of the wireless communication system 200, a high data rate wireless network may wirelessly communicate mobile data at a speed and coverage desired by individual users or enterprises. According to one embodiment, the high-speed wireless data network may comprise one or more data networks, such as Internet Protocol (IP) network comprising the Internet and a public telephone system (PSTN). The 3rd generation (3G) mobile communication system, namely Universal Mobile Telecommunication System (UMTS) supports multimedia services according to 3rd Generation Partnership Project (3GPP) specifications. The UMTS also referred as Wideband Code Division Multiple Access (WCDMA) includes Core Networks (CN) that are packet switched networks, e.g., IP-based networks. Because of the merging of Internet and mobile applications, the UMTS users can access both telecommunications and Internet resources. To provide an end-to-end service to users, a UMTS network may deploy a UMTS bearer service layered architecture specified by Third Generation Project Partnership (3GPP) standard. The provision of the end-to-end service is conveyed over several networks and realized by the interaction of the protocol layers.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of obtaining dynamic registration by at least one mobile station to an access network in a high data rate wireless network, the method comprising:
reporting location information of said at least one mobile station to said access network based on strength of pilots associated with a first set of candidate cell sectors from which said mobile station anticipates switching to a second set of target cell sectors; and
registering for a dynamic broadcast-multicast service in said high data rate wireless network based on said location information of said at least one mobile station.

2. A method, as set forth in claim 1, further comprising:
enabling said access network to support said dynamic broadcast-multicast service with said second set of target cell sectors based on said location information of said at least one mobile station in response to a handoff of said at least one mobile station.

3. A method, as set forth in claim 1, wherein reporting location information of said at least one mobile station to said access network further comprises:
monitoring the strength of pilots from said first set of candidate cell sectors to which said at least one mobile station to switch in response to the handoff.

4. A method, as set forth in claim 3, wherein monitoring the strength of pilots from said first set of candidate cell sectors further comprises:
measuring pilot strength information of one or more neighboring pilots of said pilots from said first set of candidate cell sectors.

5. A method, as set forth in claim 1, wherein reporting location information of said at least one mobile station to said access network further comprises:
sending a route update message to said access network to report said location information of said at least one mobile station, in response to adding a new pilot to said first set of candidate cell sectors, while listening to a dynamic broadcast of content to determine whether the dynamic registration of said dynamic broadcast-multicast service is desired.

6. A method, as set forth in claim 1, wherein reporting location information of said at least one mobile station to said access network further comprises:
sorting the pilots associated with said first set of candidate cell sectors based on the strength of pilots to periodically send a pilot strength list to said access network; and
determining said location information of said at least one mobile station based on pilot measurement information and said pilot strength list.

7. A method, as set forth in claim 1, further comprising:
enabling said access network to soft combine a set of one or more cell sectors from said first set of candidate cell sectors for said at least one mobile station in a physical layer.

8. A method, as set forth in claim 7, further comprising:
causing said access network to select one or more cell sectors from said first set of candidate cell sectors for said at least one mobile station to provide a desired service coverage area across one or more cells of said access network associated with said high data rate wireless network.

9. A method, as set forth in claim 8, wherein causing said access network to select one or more cell sectors further comprises:
enabling said access network to form a soft combining set of said one or more cell sectors for at least one of broadcasting and multicasting based on said location information of said at least one mobile station.

10. A method, as set forth in claim 9, wherein enabling said access network to form a soft combining set of said one or more cell sectors further comprises:
enabling said access network to use the greatest common set of cell sectors from a set of cell sectors which includes said first set of cell sectors and other cell sectors that other participating mobile stations request.

11. A method of providing dynamic registration to one or more participating mobile stations at an access network in a high data rate wireless network, the method comprising:
receiving location information based on strength of pilots associated with a first set of candidate cell sectors from each of said one or more participating mobile stations for determining whether to switch to a second set of target cell sectors in response to a handoff; and
based on said location information from said one or more participating mobile stations, registering users of a dynamic broadcast-multicast service content in said high data rate wireless network by using the greatest-common set of cell sectors from said target cell sectors requested by said one or more participating mobile stations.

12. A method, as set forth in claim 11, wherein registering users of a dynamic broadcast-multicast service content further comprises:
forming the greatest-common set of cell sectors to manage an active set for said one or more participating mobile stations in dynamic broadcasting.

13. A method, as set forth in claim 12, wherein forming the greatest-common set of cell sectors to manage an active set further comprises:
using said active set and the greatest-common set of cell sectors for providing a service coverage area across one or more cells to a set of pilots with a given strongest strength for said one or more participating mobile stations.

14. A method, as set forth in claim 13, further comprising:
forming said set of pilots with the given strongest strength for said one or more participating mobile stations from said first set of candidate cell sectors of each of said one or more participating mobile stations.

15. A method, as set forth in claim 14, further comprising:
causing said one or more participating mobile stations to listen to pilot signals of said first set of candidate cell sectors of each of said one or more participating mobile stations for determining said set of pilots with the given strongest strength.

16. A method, as set forth in claim 15, further comprising:
based on said set of pilots with the given strongest strength, releasing one or more soft combining legs, that are no longer useful, from a soft combining set of cell sectors.

17. A method, as set forth in claim 11, further comprising:
in response to a route update message from at least one mobile station of said one or more participating mobile stations, performing said handoff for at least one mobile station of said one or more participating mobile stations to said second set of target cell sectors.

18. A method, as set forth in claim 11, further comprising:
forming the greatest common set of soft combining cell sectors for said one or more participating mobile stations for dynamic broadcasting of said dynamic broadcast-multicast service content to cover users of said one or more participating mobile stations.

19. A method, as set forth in claim 18, further comprising:
receiving a list of pilot strength measurements from each of said one or more participating mobile stations for updating the greatest common set of soft combining cell sectors.

20. A method, as set forth in claim 19, wherein updating the greatest common set of soft combining cell sectors further comprises:
performing at least one of adding, deleting or maintaining the greatest common set of soft combining cell sectors based on said list of pilot strength measurements from each of said one or more participating mobile stations; and
delivering said dynamic broadcast-multicast service content only to the updated greatest common set of soft combining cell sectors for high data rate broadcasting using a given minimum number of radio resources.
